(19) United States
(12) Patent Application Publication
(10) Pub. No.: US 2003/0047042 A1
(43) Pub. Date: Mar. 13, 2003

(54) Threaded pipe installation tool system

(76) Inventor: Douglas Mickelson, Fargo, ND (US)

Correspondence Address: Michael S. Neustel, Suite No. 4, 2534 South University Drive, Fargo, ND, 58103, US

(21) Appl. No.: 09/948,515

(22) Filed: Sep. 7, 2001

(51) Int. Cl. B25B 23/00

(52) U.S. Cl. 81/459

(57) ABSTRACT

A threaded pipe installation tool system for allowing an individual to easily connect threaded pipes without requiring the usage of damaging tools. The threaded pipe installation tool system includes a handle, a female coupler removably attachable to the handle, and a male coupler removably attachable to the handle. The male coupler is comprised of a first body, an external threaded portion for engaging an interior threaded end of a pipe or pipefitting, and an engaging edge that stops the threaded engagement of the external threaded portion to allow for easy removal of the male coupler. The female coupler is comprised of a second body, an interior threaded portion for engaging a threaded end of a pipe or pipefitting, and an interior flange that stops the threaded engagement of the interior threaded portion to allow for easy removal of the female coupler.

### BACKGROUND OF THE INVENTION

1. Field of the Invention

The present invention relates generally to pipe manipulation tools and more specifically it relates to a threaded pipe installation tool system for allowing an individual to easily connect threaded pipes without requiring the usage of damaging tools.

2. Description of the Prior Art

Pipe manipulation tools have been in use for years. The most common type of pipe manipulation tool is often times referred to as the “pipe wrench.” The pipe wrench typically is comprised of an elongate handle, a first jaw nonmovably attached to the handle, and a second jaw movably attached to the handle. The first jaw and the second jaw both have a plurality of gripping teeth that engage the outer surface of a pipe or pipefitting.

The main problem with conventional pipe manipulation tools is that they often time mar the outer surface of the pipe or pipefitting thereby reducing the aesthetic appearance of the pipe. A further problem with conventional pipe manipulation tools is that they are bulky and difficult to utilize. Another problem with conventional pipe manipulation tools is that they are not suitable for usage within compact areas. A further problem is that a conventional pipe manipulation tool, such as a pipe wrench, sometimes damage the threading upon the pipe or pipefitting thereby increasing the chances of a leaky seal.

Examples of patented devices which are related to the present invention include U.S. Pat. No. 3,279,053 to Neuschotz; U.S. Pat. No. 3,807,028 to DeLuca; U.S. Pat. No. 3,545,066 to Stillman; U.S. Pat. No. 3,137,186 to Rosan; U.S. Pat. No. 5,617,623 to Schron; U.S. Pat. No. 4,589,178 to Staffeld; U.S. Pat. No. 3,769,861 to Kisle.

While these devices may be suitable for the particular purpose to which they address, they are not as suitable for allowing an individual to easily connect threaded pipes without requiring the usage of damaging tools. Conventional pipe manipulating devices are difficult to utilize and often times leave the pipe and/or pipefittings marred.

In these respects, the threaded pipe installation tool system according to the present invention substantially departs from the conventional concepts and designs of the prior art, and in so doing provides an apparatus primarily developed for the purpose of allowing an individual to easily connect threaded pipes without requiring the usage of damaging tools.

### SUMMARY OF THE INVENTION

In view of the foregoing disadvantages inherent in the known types of pipe manipulating devices now present in the prior art, the present invention provides a new threaded pipe installation tool system construction wherein the same can be utilized for allowing an individual to easily connect threaded pipes without requiring the usage of damaging tools.

The general purpose of the present invention, which will be described subsequently in greater detail, is to provide a new threaded pipe installation tool system that has many of the advantages of the pipe manipulation tools mentioned heretofore and many novel features that result in a new threaded pipe installation tool system which is not anticipated, rendered obvious, suggested, or even implied by any of the prior art pipe manipulation devices, either alone or in any combination thereof.

To attain this, the present invention generally comprises a handle, a female coupler removably attachable to the handle, and a male coupler removably attachable to the handle. The male coupler is comprised of a first body, an external threaded portion for engaging an interior threaded end of a pipe or pipefitting, and an engaging edge that stops the threaded engagement of the external threaded portion to allow for easy removal of the male coupler. The female coupler is comprised of a second body, an interior threaded portion for engaging a threaded end of a pipe or pipefitting, and an interior flange that stops the threaded engagement of the interior threaded portion to allow for easy removal of the female coupler.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a threaded pipe installation tool system that will overcome the shortcomings of the prior art devices.

A second object is to provide a threaded pipe installation tool system for allowing an individual to easily connect threaded pipes without requiring the usage of damaging tools.

Another object is to provide a threaded pipe installation tool system that is easy to utilize for most individuals.

An additional object is to provide a threaded pipe installation tool system that does not mar the outer surface of the pipe or pipefitting.

A further object is to provide a threaded pipe installation tool system that does not damage the threading of a pipe or pipefitting.

Another object is to provide a threaded pipe installation tool system that may be utilized within compact locations.

A further object is to provide a threaded pipe installation tool system that may be compactly stored and easily carried by an individual.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the male coupler of the present invention.

FIG. 2 is an upper perspective view of the female coupler of the present invention.

FIG. 3 is an exploded upper perspective view of the female coupler with respect to a pipe along with the handle.

FIG. 4 is a side view of the male coupler.

FIG. 5 is a side view of the female coupler.

FIG. 6 is a front end view of the female coupler.

FIG. 7 is a front end view of the male coupler.

FIG. 8 is a rear end view of the female coupler which is similar to the rear end of the male coupler.

FIG. 9 is a cross sectional view taken along line 9-9 of FIG. 6 illustrating the interior portion of the female coupler.

FIG. 10 is a cross sectional view taken along line 10-10 of FIG. 7 illustrating the interior portion of the male coupler.

FIG. 11 is an exploded side view of the female coupler with respect to a pipe.

FIG. 12 is a side view illustrating the female coupler position about the male threads of a first pipe prior to threadably inserting the first pipe into a second pipe.

FIG. 13 is a side view illustrating the first pipe threadably inserted into the second pipe.

FIG. 14 is a cross sectional view taken along line 14-14 of FIG. 12 illustrating the male end of the first pipe threadably received within the interior threads of the female coupler with the end of the first pipe abutting the interior flange.

FIG. 15 is an exploded upper perspective view of the handle with respect to the male coupler.

FIG. 16 is a side view of the male coupler positioned within an elbow member pipefitting for rotating the elbow member upon a pipe.

### DESCRIPTION OF THE PREFERRED EMBODIMENT

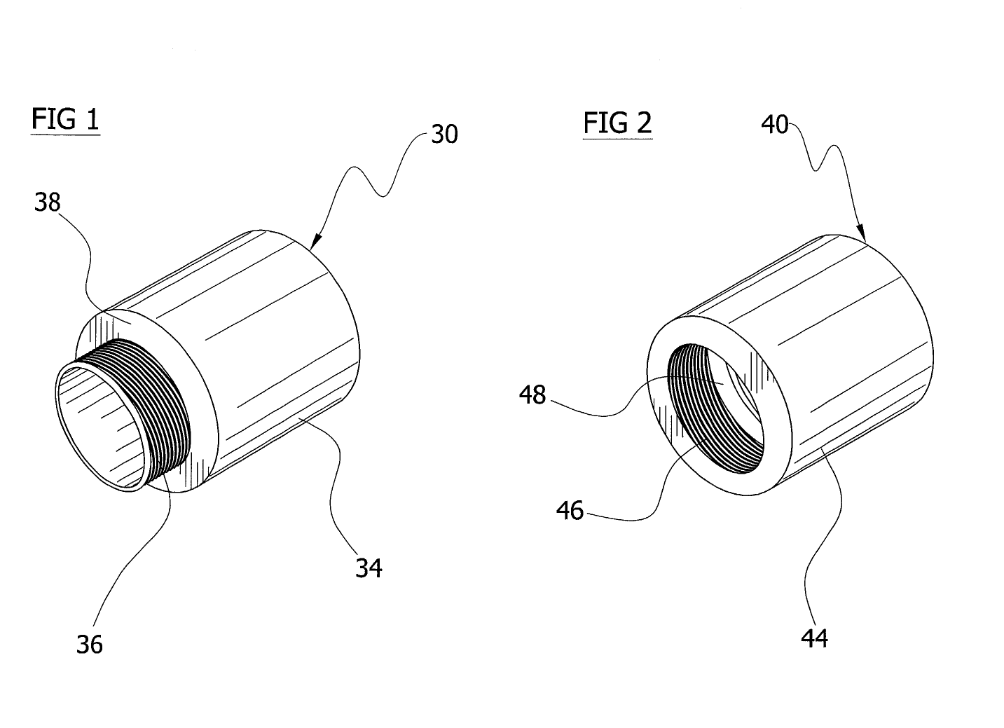

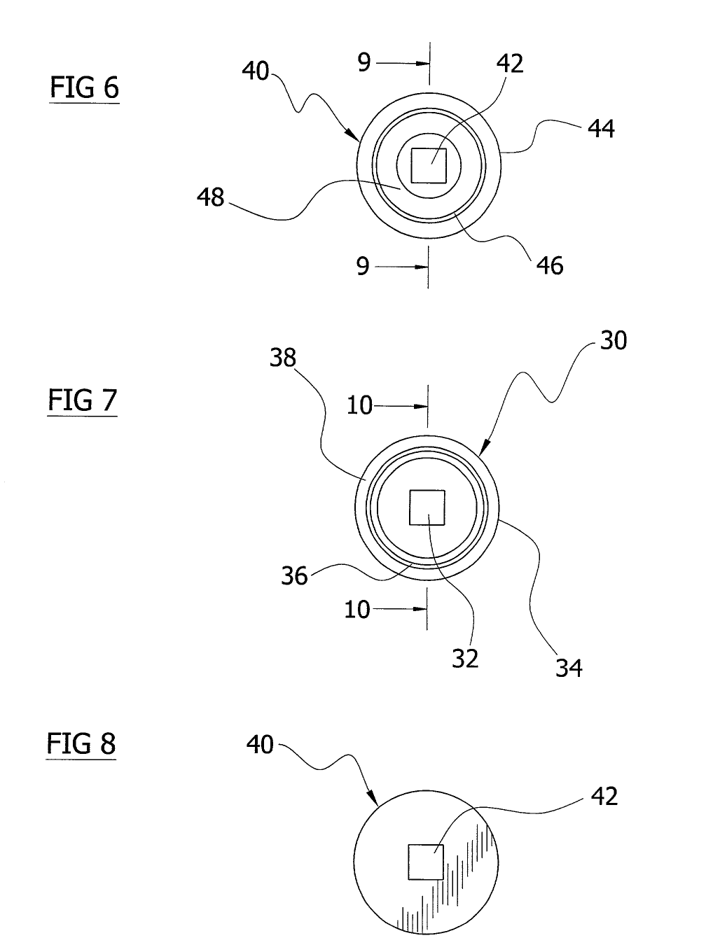

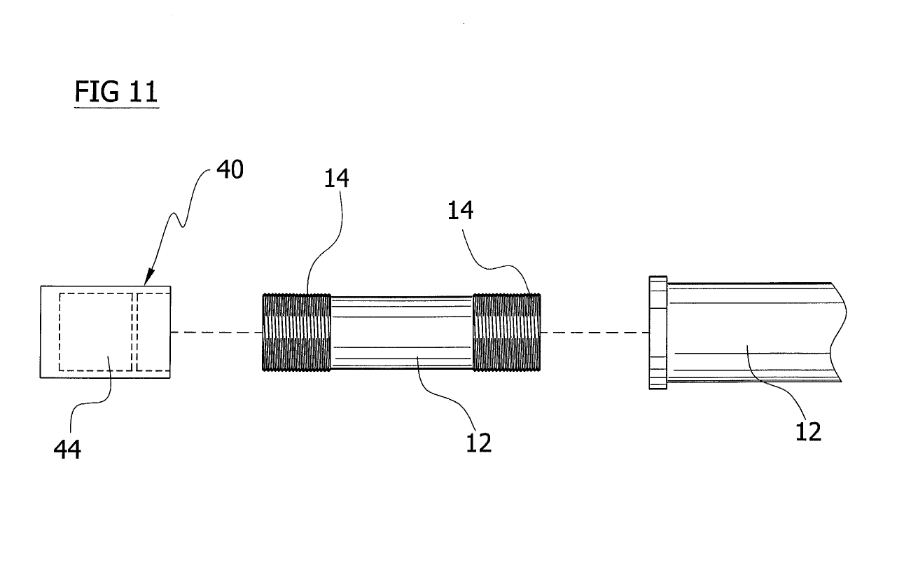

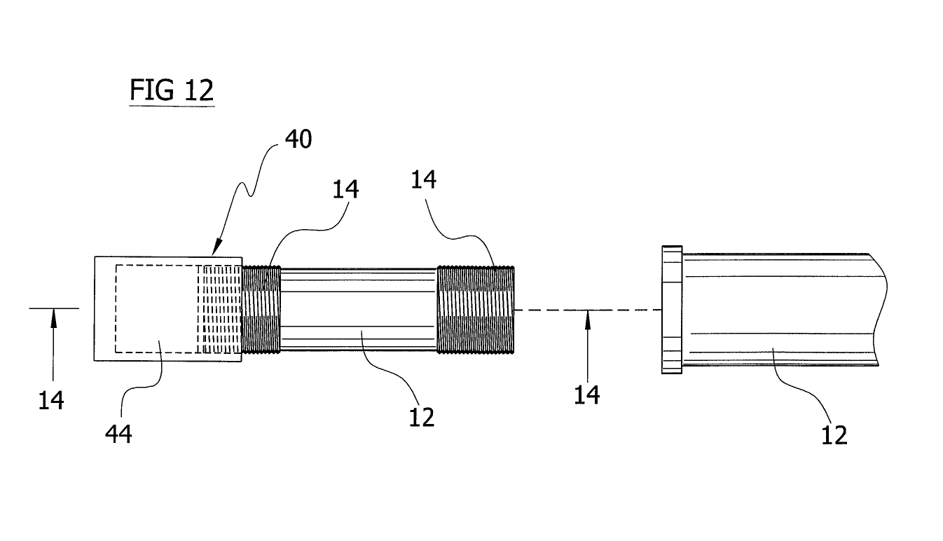

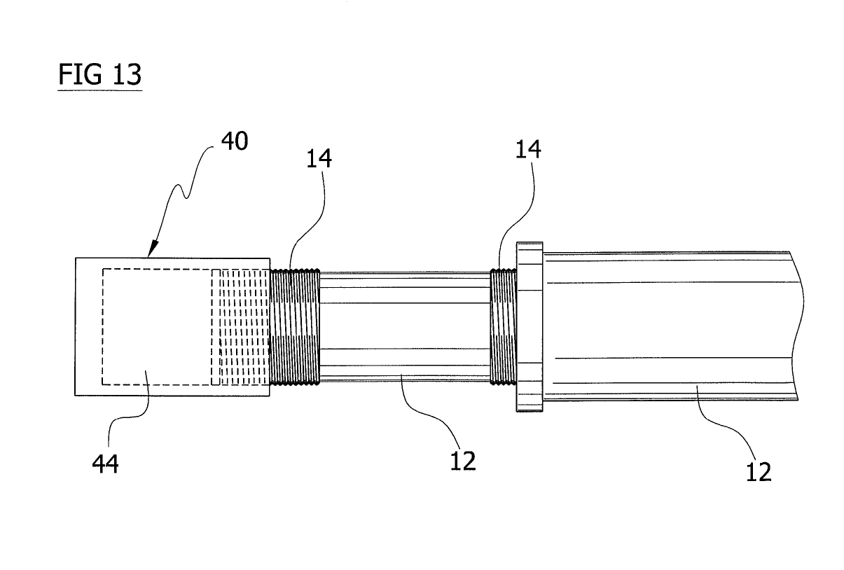

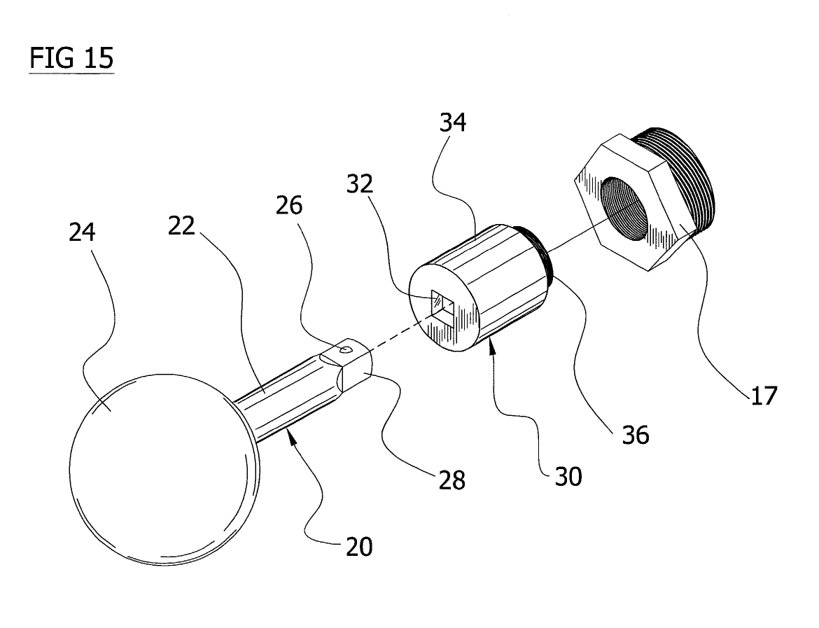

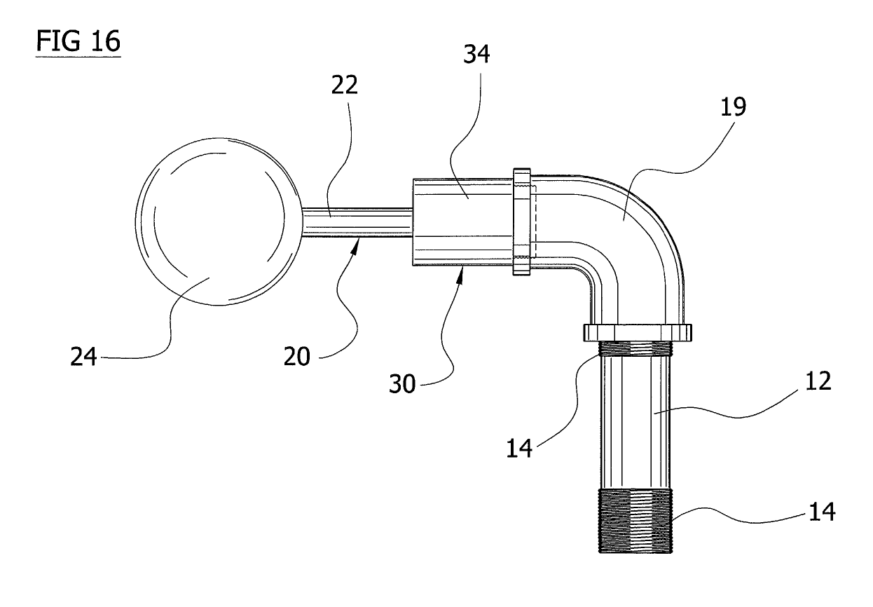

Turning now descriptively to the drawings, in which similar reference characters denote similar elements throughout the several views, FIGS. 1 through 16 illustrate a threaded pipe installation tool system 10, which comprises a handle 20, a female coupler 40 removably attachable to the handle 20, and a male coupler 30 removably attachable to the handle 20. The male coupler 30 is comprised of a first body 34, an external threaded portion 36 for engaging an interior threaded end 16 of a pipe 12 or pipefitting 17, and an engaging edge 38 that stops the threaded engagement of the external threaded portion 36 to allow for easy removal of the male coupler 30. The female coupler 40 is comprised of a second body 44, an interior threaded portion 46 for engaging a threaded end 14 of a pipe 12 or pipefitting 17, and an interior flange 48 that stops the threaded engagement of the interior threaded portion 46 to allow for easy removal of the female coupler 40.

A conventional pipe 12 or pipefitting 17 has either at least one threaded end 14 or interior threaded end 16. The threaded end 14 and the interior threaded end 16 are tapered slightly for allowing for easy attachment to one another initially and then providing for a snug engaging for providing sealed connections.

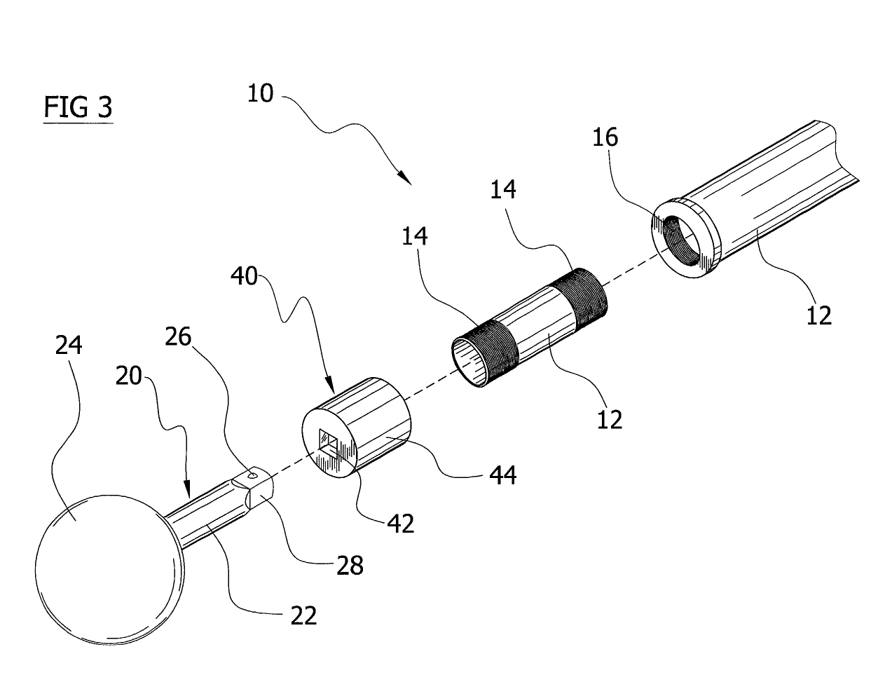

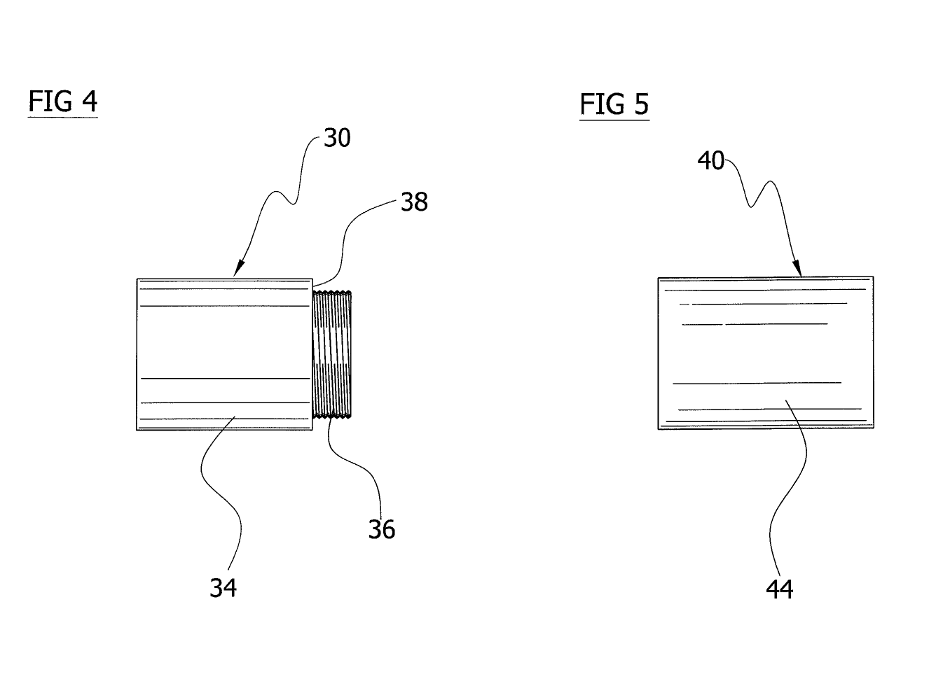

As shown in FIGS. 3, 15 and 16 of the drawings, the handle 20 is basically comprised of an elongate shaft 22, a head 24 attached to the shaft 22, and an engaging end 28 upon the shaft 22 opposite of the head 24. The handle 20 may have various other shapes and structures as can be appreciated. The handle 20 is preferably a spherical shaped structure for allowing easy rotation of the handle 20 when secured to either the male coupler 30 or the female coupler 40.

The engaging end 28 of the handle 20 is formed for snugly fitting within the openings 32, 42 of the couplers 30, 40 respectively. The engaging end 28 may have various sizes such as but not limited to ⅜ or ½ inch. The engaging end 28 may have various shapes as can be appreciated. The engaging end 28 preferably includes a detent ball 26 for allowing catchable attachment of the handle 20 within the couplers 30, 40. It can be appreciated that alternatively a ratchet or an impact wrench may be utilized having a suitable coupler size to fit within the openings 32, 42 of the couplers 30, 40 respectively. Various other types of tools may also be interchanged with the handle 20.

As shown in FIGS. 1, 4, 7 and 10 of the drawings, the male coupler 30 is comprised of a first body 34, an external threaded portion 36 for engaging an interior threaded end 16 of a pipe 12 or pipefitting 17, and an engaging edge 38 that stops the threaded engagement of the external threaded portion 36 to allow for easy removal of the male coupler 30. The first body 34 may have various shapes and sizes as can be appreciated. The male coupler 30 may also be comprised of various types of materials such as but not limited to metal and plastic. The external threaded portion 36 may have various diameters and threading sizes as may be required to fit upon various types of pipes 12 or pipefittings 17.

The engaging edge 38 has a broader diameter than the external threaded portion 36 as is best illustrated in FIG. 4 of the drawings. The inner surface of the engaging edge 38 engages the end of the pipe 12 or pipefitting 17 to allow for easy removal of the male coupler 30 from the pipe 12 or pipefitting 17 as shown in FIG. 16 of the drawings. The male coupler 30 may also be utilized to engage an elbow member 19 to allow for rotation of the elbow member 19 upon a pipe 12. The male coupler 30 also includes a first opening 32 within a rear portion of the first body 34 for receiving an engaging end 28 of the handle 20.

The female coupler 40 is comprised of a second body 44 having various shapes and sizes as shown in FIGS. 2, 3, 5 and 9 of the drawings. The female coupler 40 further includes an interior threaded portion 46 that is threadably attachable to the threaded end 14 of a pipe 12 or pipefitting 17. The interior threaded portion 46 may have various diameters and threading sizes as may be required to secure to various sizes of pipes 12 and pipefittings 17.

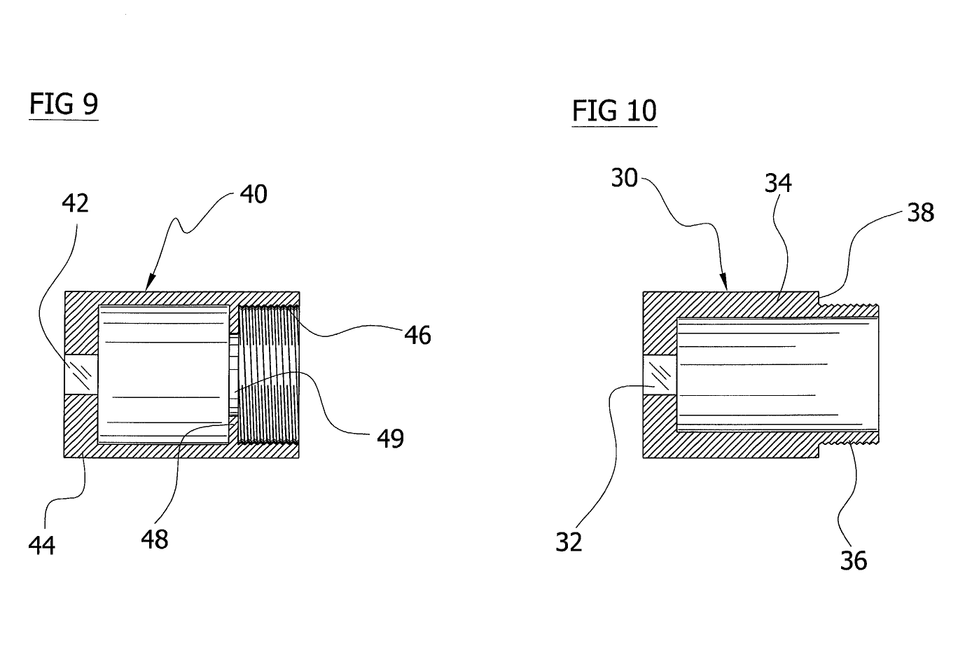

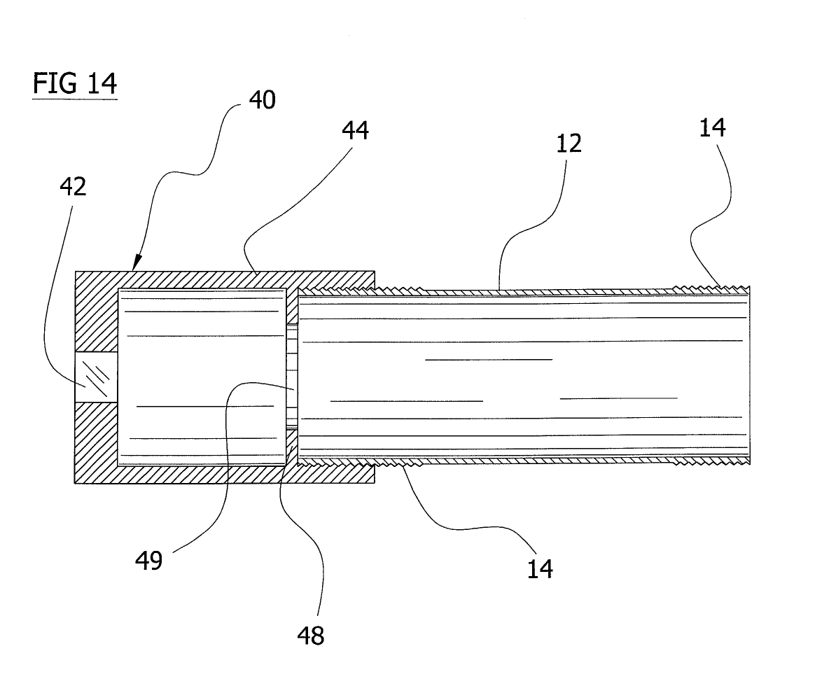

As shown in FIG. 9 of the drawings, an interior flange 48 extends inwardly from the inner surface of the second body 44 adjacent to the interior threaded portion 46. The interior flange 48 extends inwardly a finite distance with a central opening preferably positioned within. It can be appreciated that the interior flange 48 may be comprised of a solid structure without the central opening. The interior flange 48 limits the entry of the threaded end 14 of a pipe 12 thereby allowing the female coupler 40 to be easily removed as shown in FIG. 14 of the drawings. The female coupler 40 also includes a second opening 42 within a rear portion of the second body 44 for receiving the engaging end 28 of the handle 20.

In use, the user may carry one or more male couplers 30 and female couplers 40 along with the handle 20 within a compact and disassembled structure. When the user requires usage of one of the couplers 30, 40, the user simply attaches the desired coupler 30, 40 to the engaging end 28 of the handle 20 and then manipulates the handle 20 as stated above to attach a pipe 12 or pipefitting 17 to another pipe 12 or pipefitting 17. When finished, the user removes the coupler 30, 40 from the pipe 12 and then disassembles the coupler 30, 40 from the handle 20 and then positions within a convenient location.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A threaded pipe installation tool system, comprising:
a handle comprised of a shaft having an engaging end and a head attached to said shaft opposite of said engaging end; and
a male coupler comprised of a first body, a first opening for removably receiving said engaging end, an external threaded portion within said first body for threadably engaging an interior threaded end of a pipe or pipefitting, and an engaging edge adjacent said external threaded portion.

2. The threaded pipe installation tool system of claim 1, wherein said engaging end includes a detent ball.

3. The threaded pipe installation tool system of claim 2, wherein said external threaded portion has a length less than 20 percent of a length of said first body.

4. The threaded pipe installation tool system of claim 3, wherein said engaging edge has a diameter greater than a diameter of said external threaded portion by at least 0.10 inches.

5. The threaded pipe installation tool system of claim 4, wherein said first opening is comprised of a square shape.

6. The threaded pipe installation tool system of claim 5, wherein said head is comprised of a spherical shape.

7. The threaded pipe installation tool system of claim 6, wherein said head has a diameter greater than a diameter of said first body.

8. The threaded pipe installation tool system of claim 7, including a female coupler comprised of a second body having an interior threaded portion for threadably receiving a threaded end of a pipe or pipe fitting, a second opening for removably receiving said engaging end, and an interior flange within an interior portion of said second body adjacent said interior threaded portion.

9. The threaded pipe installation tool system of claim 8, wherein said interior flange includes a central opening within.

10. The threaded pipe installation tool system of claim 8, wherein said interior flange is comprised of a solid structure.

11. A threaded pipe installation tool system, comprising:
a handle comprised of a shaft having an engaging end and a head attached to said shaft opposite of said engaging end; and
a female coupler comprised of a second body having an interior threaded portion for threadably receiving a threaded end of a pipe or pipe fitting, a second opening for removably receiving said engaging end, and an interior flange within an interior portion of said second body adjacent said interior threaded portion.

12. The threaded pipe installation tool system of claim 11, wherein said engaging end includes a detent ball.

13. The threaded pipe installation tool system of claim 12, wherein said interior threaded portion has a length less than 20 percent of an overall length of said second body.

14. The threaded pipe installation tool system of claim 13, wherein said interior flange has an inner diameter lesser than a diameter of an inner lumen of said second body by at least 0.10 inches.

15. The threaded pipe installation tool system of claim 14, wherein said second opening is comprised of a square shape.

16. The threaded pipe installation tool system of claim 15, wherein said head is comprised of a spherical shape.

17. The threaded pipe installation tool system of claim 16, wherein said head has a diameter greater than a diameter of said second body.

18. The threaded pipe installation tool system of claim 17, wherein said interior flange includes a central opening within.

19. The threaded pipe installation tool system of claim 17, wherein said interior flange is comprised of a solid structure.

20. A method of operating a threaded pipe installation tool system having a handle comprised of a shaft having an engaging end and a head attached to said shaft opposite of said engaging end, a male coupler comprised of a first body, a first opening for removably receiving said engaging end, an external threaded portion within said first body for threadably engaging an interior threaded end of a pipe or pipefitting, and an engaging edge adjacent said external threaded portion, and a female coupler comprised of a second body having an interior threaded portion for threadably receiving a threaded end of a pipe or pipe fitting, a second opening for removably receiving said engaging end, and an interior flange within an interior portion of said second body adjacent said interior threaded portion, said method comprising the steps of:
(a) inserting said engaging end of said handle into said second opening of said female coupler;
(b) threadably engaging said interior threaded portion of said female coupler about a first threaded end of a first pipe until a distal end of said first pipe engages said interior flange;
(c) threadably engaging a second threaded end of said first pipe into an interiorly threaded end of a second pipe or pipefitting until said first pipe is tightened within said second pipe or pipefitting;
(d) threadably removing said female coupler from said first pipe; and
(e) disassembling said female coupler from said handle.
